(19) United States
(12) Patent Application Publication
(10) Pub. No.: US 2011/0277328 A1
(43) Pub. Date: Nov. 17, 2011

(54) STRING TRIMMER SHIELD

(76) Inventor: EDWARD HURLEY, SARASOTA, FL (US)

(21) Appl. No.: 12/777,288

(22) Filed: May 11, 2010

(51) Int. Cl. A01D 34/81

(52) U.S. Cl. 30/286

(57) ABSTRACT

A string trimmer shield for use in connection with conventional string trimmers which have a rotary cutting head that is attached to a lower end of an elongated shaft or handle and includes at least one string cutting element extending radially from the cutting head that rotates through a circular path. The string trimmer shield includes an airflow reaction surface that together with an airflow created by the rotating string cutting element stabilizes the string cutting element at least through a portion of its circular path of rotation. The string trimmer shield may further include a string cutting element trimming blade comprising a cutting edge spanning a notch which prevents the string cutting element from sliding off the cutting edge. The string trimmer shield may further include vents through a deck of the string trimmer shield to vent the underside of the string trimmer shield.

### FIELD OF THE INVENTION

The present invention relates generally to string trimmers, and more particularly, relating to string trimmer shield that stabilizes a string cutting element through at least a portion of its rotation.

### BACKGROUND OF THE INVENTION

Lawn tools are highly desirable for use, particularly where horizontal trimming and vertical edging of lawns is required. Some of the most common outdoor power tools are gas and electric string trimmers. Typically, string trimmers include a handle, a motor, an elongated shaft and a lower cutting head from which the string cutting element extends and rotates to cut grass, weeds, and other vegetation. The motor may be mounted at a lower end of the elongated shaft or it may be mounted at the opposite end of the elongated shaft (near the operator) depending on the style of the trimmer. Furthermore, the string trimmers may be powered by combustible fuel engines, as well as electric motors. The versions driven by electric motors may be connected to a line source such as 120 volt alternating current electric power, or they may be powered by a battery pack or other source of direct current electrical power.

Many string trimmers include a string trimmer shield designed to deflect debris traveling rearwardly away from the housing towards the ground or to the sides of the trimmer housing. When used in connection with flexible line trimmers, the shields may also include a cutting element such as a blade to automatically trim the cutting line to the proper length for rotation within the trimmer shield.

String trimmers heretofore, have not provided a solution to the undesirable, non-planar and irregular rotation of a string cutting element resulting in the string cutting elements from slicing vegetation and coming into contact with ground disturbances.

### SUMMARY OF THE INVENTION

Embodiments of present invention provides a string trimmer shield for use in connection with string trimmers, which stabilizes the rotation of a string cutting member at least along a portion of its rotation.

Embodiments of the present invention also provide string trimmer shield including vents to prevent the collection of air, hot gases and debris beneath the string trimmer shield.

Embodiments of the present invention further provide a string cutting element trimming blade including a notch to prevent the string cutting element from sliding off the cutting edge of the blade.

Embodiments of the present invention further provide a string trimmer shield having a reinforced deck structure void of reinforcing ribs.

Embodiments of the present invention further provide a string trimmer shield having an increased opening along a length of the string trimmer shield deck permitting a greater flow of air below the string trimmer shield.

To achieve these and other advantages, in general, in one aspect, string trimmer shield for use with a string trimmer, the string trimmer having a string cutting element rotated along a generally planar circular pathway, the rotation of the string cutting element creating an air flow in the direction of rotation thereof. The string trimmer shield including a deck having first end configured for mounting to a string trimmer, and an opposite arcuate shaped second end. A skirt depends from the arcuate shaped second end, and an underside of the deck has an air flow reaction surface, whereby the string cutting element is stabilized is it passes across said air flow reaction surface.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a top perspective view of a string trimmer shield constructed in accordance with the principles of the present invention;

FIG. 2 is a bottom perspective view of the string trimmer shield of FIG. 1;

FIG. 3 is a side elevation, cross-section view of the string trimmer shield, illustrating a partial length of a string cutting element;

FIG. 4 is a bottom plan view of the string trimmer, illustrating a partial length of a string trimmer through a portion of a circular path of rotation; and

FIG. 5 is a side elevation view of the string trimmer, illustrating a blade for cutting a string cutting member.

### DETAILED DESCRIPTION OF THE INVENTION

As a preliminary matter, it should be noted that in this document (including the claims), the terms “comprise” (and any form thereof, such as “comprises” and “comprising”), “have” (and any form thereof, such as “has” and “having”), and “include” (and any form thereof, such as “includes” and “including”) are open-ended transitional terms. Thus, a thing (such as a string trimmer shield) that “comprises,” “has,” or “includes” one or more elements possesses those one or more elements, but is not limited to only possessing those one or more elements.

Further, it should be noted that in this document (including the claims) directional terms, such as “above”, “below”, “upper”, “lower”, etc., are used for convenience in referring to the accompanying drawings. Additionally, it is to be understood that the various embodiments of the present invention described herein may be utilized in various orientations, such as inclined, inverted, horizontal, vertical, etc., without departing from the principles of the present invention.

The present disclosure provides a string trimmer shield for use in connection with conventional string trimmers which have a rotary cutting head that is attached to a lower end of an elongated shaft or handle and includes at least one string cutting element extending radially from the cutting head that rotates through a circular path. Since string trimmers are well known in the art, and do not form any part of the present invention, a complete description of a string trimmer is not required. In an aspect, the string trimmer shield of the present disclosure functions to stabilize the rotating string cutting element throughout at least a portion of its circular rotational path.

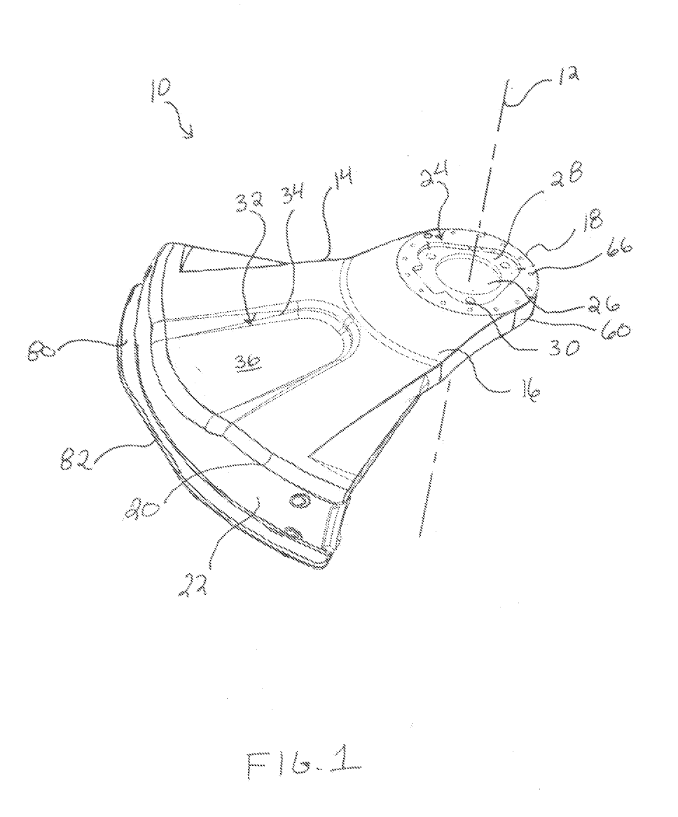

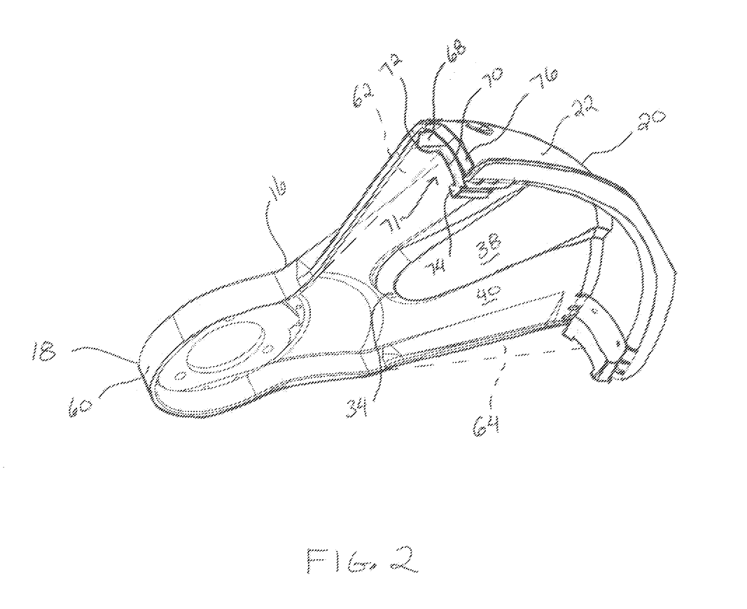

Representatively illustrated in FIGS. 1 and 2 is a string trimmer shield 10 which embodies principles of the invention. The flowing disclosure of the string trimmer shield is made generally in reference to an axis of rotation 12 about which the string cutting element rotates when the string trimmer is in use. The string trimmer shield 10 includes a body 14 of a unitary construction made of any suitable material for the manufacture of a string trimmer shield. As a non-limiting example, body 14 could be made of plastics, polymers and the like. Body 14 comprises a deck 16 that extends in generally radial outward direction from axis 12 along a plane generally normal to axis 12. As shown, the deck 16 extends between ends 18 and 20 and tapers from narrow to wide along a direction from end 18 towards end 20. It is preferred end 20 is arcuate shaped such that a portion of the circular path of the string cutting element moves within or below deck 16 during a portion of its rotation. It is neither preferred or desirable that deck 16 extend completely around the path of the string cutting element because at least a portion of that path should be open to allow the string cutting element to slice vegetation as it rotates.

Body 14 further comprises a skirt 22 extending in a downward direction from the deck 16. In an embodiment, skirt 22 extends along and downward from end 20 of the deck 16. Skirt 22 shields the end of the string cutting element during its rotation below deck 16, and prevents debris from flying radially outwardly from below the deck 16.

As shown in FIG. 1, the string trimmer 10 of the present disclosure also comprises a mount 24 at end 18 of the deck 16. Mount 24 is configured to secure the string trimmer shield 10 to a string trimmer with a portion of the cutting head drive assembly extending opening 26. In most applications, and preferably, the string trimmer shield 10 will be secured to a string trimmer with at least a portion of the deck 16 about opening 26 between a gear box that is operatively connected to the cutting head and the cutting head. One of ordinary skill in the art will appreciate the particular configuration of mount 24 can be varied in accordance with various shield mounting structures provided by various string trimmers.

As depicted in FIG. 1, and in one exemplary configuration, mount 24 includes a keyed generally triangular recessed portion 28 on an exterior side of the deck 16. Opening 26 is centrally located within the recessed portion 28 through which will extend the cutting head drive assembly of the string trimmer when the string trimmer shield 10 is mounted to the string trimmer. A plurality of mounting bolts holes 30 are spaced at equal intervals around opening 20 through which threaded bolts may be passed and threadably received by the string trimmer to secure the string trimmer shield 10 to the string trimmer.

Deck 16 comprises a depression 32 extending radially from approximately a mid portion thereof to end 20 and forming a recessed surface 36. While depression 32 is depicted as only extending a portion of the deck 12, it could extend a lesser or greater distance. Further, while deck 16 is depicted as only including one depression 32, two or more spaced depression could be included. The peripheral sidewall 34 and the recessed surface 36 of the depression 32 is continuous with the top surface 42 deck 12 and forms a smooth transition. Peripheral sidewall 34 performs two functions. One, peripheral sidewall 34 provides supporting structure for deck 16 which resists the bending and twisting of deck 16, and thus preventing cracking or damage. Second, as will be described in more detail below, peripheral sidewall 34 provides a smooth transition surface between adjacent air flow surfaces on an underside of deck 16.

In FIG. 2 there is illustrated a perspective of the underside of deck 16. Here is can be seen that the depression 32 provides a surface 38 projected from bottom surface 40 on the underside of deck 16 that is opposite of the recessed surface 36 on the topside of deck 16. Surface 38, bottom surface 40 and the bottom surface of sidewall 34 are continuous, wherein the bottom surface of sidewall 34 provides a smooth transition between surfaces 38 and 40.

It is known the rotation of the string cutting element through its circular path creates an airflow that is generally tangential to the circular path in the direction of rotation of the string cutting element. Some string trimmers have been developed to capture and duct the airflow induced by the rotation of the string cutting element to provide a debris blower.

It is also known, in operation, as the string cutting element severs vegetation or comes into contact with solid obstacles which cannot be cut, the string cutting element is caused to deviate along its length from the ideal planar circular path of rotation. In this case, the string cutting element will typically rotate through an irregular, non-planar and non-linear path of rotation. Ideally, to maintain the highest cutting efficiency, the string cutting element should remain in a circular path of rotation in a plane that is normal to its axis of rotation. Further, it is desirable for the string cutting element to remain in a planar circular path of rotation to prevent undesirable stresses in the string trimmer, as a result of the string cutting element rotating through an irregular path of rotation. The string trimmer shield 10 of the present disclosure utilizes the airflow induced by the rotation of the string cutting element to stabilize the string cutting element through at least a portion of its circular path of rotation.

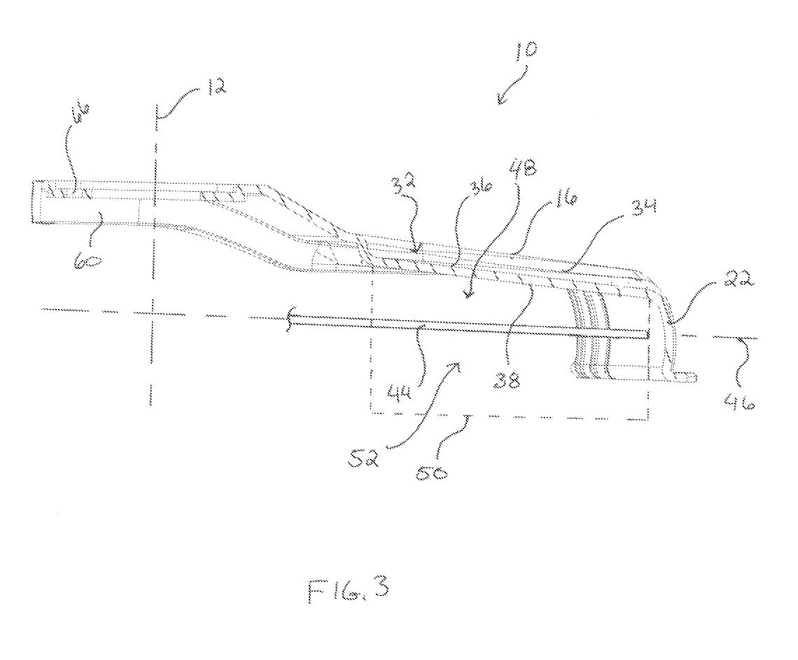

FIG. 3 shows a side cross-section of the string trimmer shield 10. Further shown is an end portion of a string cutting element 44 rotating about axis 12 in plane 46. Plane 46 is transverse and normal to axis 12 and indicates the ideal rotational plane of string cutting element 44. String cutting element 44 is shown below deck 16 extending radially across surface 38 and stabilized along rotational plane 46. String cutting element 44 is stabilized along its radial length as it passes through first and second regions of air 48 and 52 located across surface 38. The region of air 48 extends in a space generally defined and between rotational plane 46, surface 38 and planes 50 (only one of which is shown) extending normal to rotational plane 46 and through the side edges of surface 38. Opposite rotational plane 46 exists region of air 52. Regions of air 48 and 52 are comprised of air having dissimilar pressures, and generally intersect along plane 46. As string cutting element 44 rotates through regions of air 48 and 52 the differential air pressures act in opposite directions along the length of the string cutting element and urges the string cutting element to align generally along its length in plane 46 at the insertion of the regions of air 48 and 52. This alignment, results in a stabilization of the string cutting element 44.

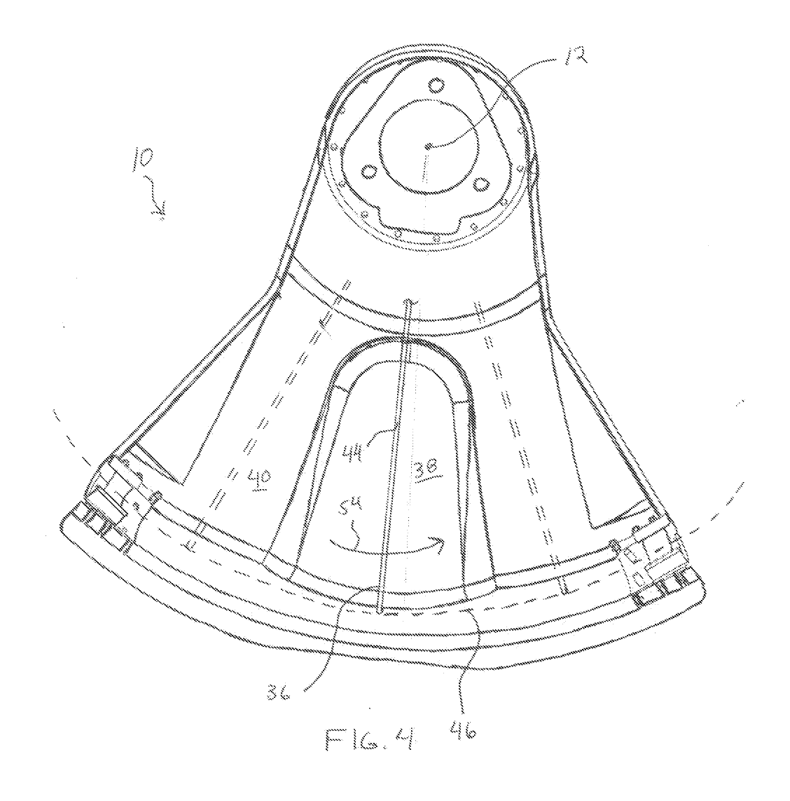

The regions of air 48 and 52 having dissimilar pressures is created by the flow of air 54 induced by the rotation of the string cutting element 44 as it flows across the underside of deck 16 as it transitions from surface 40 to surface 38 and back to surface 40, as depicted in FIG. 4. Surface 38 provides an airflow reaction surface, not dissimilar to an airfoil, and forms an air boundary layer across surface 38 resulting in the two regions of air 48 and 52.

The string trimmer shield 10 further comprises a reinforcement rim 60 as best shown in FIGS. 1 and 2. Rim 60 depends from deck 16 around the perimeter thereof and generally normal to deck 16 around end 18 and then twists about itself in a generally outward flare in a direction from end 18 towards end 20 where it becomes generally parallel to deck 16. In this manner, an increased opening is provided at the forward end of deck 16, generally indicated by phantom surfaces 62 and 64, to permit a greater volume of air to pass below deck 16, and to additionally prevent air from stagnation below deck 16.

In embodiments, the string trimmer shield 10 may further comprised vent holes 66 extending through deck 16, as depicted in FIGS. 1 and 3. Vent holes 66 prevent the underside of the string trimmer shield 10 from collecting excess air, hot gases and or debris. In an embodiment, the vents holes 66 are circumferentially spaced around opening 26 and serve to cool a gear box is disposed above vent holes 66.

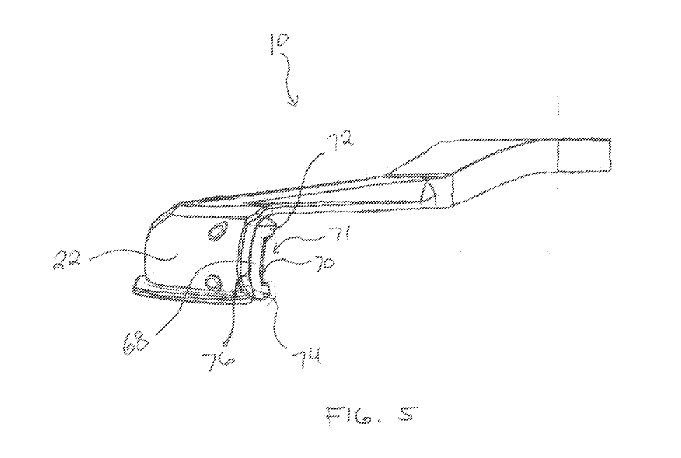

The string trimmer 10 may further comprise one or more blades 68 for cutting excess length of a string cutting element, such as for example when dispensed from an automatic feed. Blade 68 can be seen, for example, in FIGS. 2 and 5 and are positioned such that the cutting edge of the blade is transverse to the string cutting element and extend generally vertically along the inward side of skirt 22. In an embodiment, as best seen in FIG. 5, blade 68 is includes a notch 71 which the cutting edge 70 is disposed. As an end of a string cutting element rotates into contact with cutting edge 70, projections 72 and 74 prevent the string cutting element from sliding off the cutting edge. Edge 76 of the skirt can also be notched to correspond with blade notch 71.

In an aspect, blade 68 may be inwardly disposed in a radially direction from skirt 22 forming a gap 78 between the blade 68 and the skirt. The gap 78 permits air to flow between the blade 68 and the skirt 22 preventing slack in the string cutting element that otherwise may be caused by an area of air pressure leading the rotation of the string cutting element across the edge of the skirt 22. Additionally, while blade 68 is shown curved, one skilled in the art will appreciate it may take other forms, such as slanted or straight.

String trimmer shield 10 may further comprise a skid 80 extending in a generally outward direction from the bottom edge of skirt 22. Skid 80 may have a flattened edge 82 approximate a middle thereof.

A number of embodiments of the present invention have been described. Nevertheless, it will be understood that various modifications may be made without departing from the spirit and scope of the invention. Accordingly, other embodiments are within the scope of the following claims.

What is claimed is:

1. A string trimmer shield for use with a string trimmer, the string trimmer having a string cutting element rotated along a generally planar circular pathway, the rotation of said string cutting element creating an air flow in the direction of rotation thereof, the string trimmer shield comprising:
a deck having first end configured for mounting to a string trimmer, and an opposite arcuate shaped second end;
a skirt depending from said arcuate shaped second end; and
an underside of said deck having an air flow reaction surface, whereby the string cutting element is stabilized is it passes across said air flow reaction surface.

2. The string trimmer shield of claim 1, wherein said air flow reaction surface projects outwardly from and is conjoined with planar surfaces extending opposing sides of said flow reaction surface.

3. The string trimmer shield of claim 1, wherein said air flow reaction surface extends radially in a direction generally between said first end and said arcuate shaped second end.

4. The string trimmer shield of claim 1, wherein said air flow reaction surface tapers from narrow to wide along a radial direction from said first end towards said second end.

5. The string trimmer shield of claim 1, wherein a bottom surface of said deck defines said air flow reaction surface and said planar surfaces, and wherein said bottom surface further defines smooth and continuous transition surfaces conjoining said air reaction surface and said planar surfaces.

6. The string trimmer shield of claim 1, a rim depending from said deck around the perimeter thereof and generally normal to said deck around said first end and then twists about itself in a generally outward flare in a direction from said first end towards said second end where it becomes generally parallel said deck.

7. The string trimmer shield of claim 1, further comprising:
vent holes through said deck.

8. The string trimmer shield of claim 1, further comprising:
a mount at said first end of said deck.

9. The string trimmer shield of claim 1, further comprising:
a blade having a cutting edge spanning a notch, said blade extending said skirt.
